(19) United States
(12) Patent Application Publication
(10) Pub. No.: US 2017/0160676 A1
(43) Pub. Date: Jun. 8, 2017

(54) PROCESSING ELECTRO FLUID

(71) Applicant: HEWLETT-PACKARD INDIGO B.V., Amstelveen (NL)

(72) Inventors: Giries Kadis, Jaffa (IL); Yaron Grinwald, Meitar (IL)

(21) Appl. No.: 15/326,000

(22) PCT Filed: Jul. 31, 2014
(86) PCT No.: PCT/EP2014/066550

§ 371 Date: Jan. 12, 2017

(51) Int. Cl. G03G 15/10

(52) U.S. Cl. CPC G03G 15/104; G03G 15/11; G03G 2215/0626

(57) ABSTRACT

An apparatus to concentrate electro fluid. The apparatus comprising an electrically grounded drum, a fluid feed to provide electro fluid to the surface of the drum and a roller. The roller comprising a metal core to be electrically biased and a ceramic coating around the metal core.

### BACKGROUND

In some examples electro fluid, such as ink, may be transported for use in printing. The electro fluid may be concentrated for transportation.

### BRIEF DESCRIPTION

Reference will now be made by way of example only to the accompanying drawings in which:

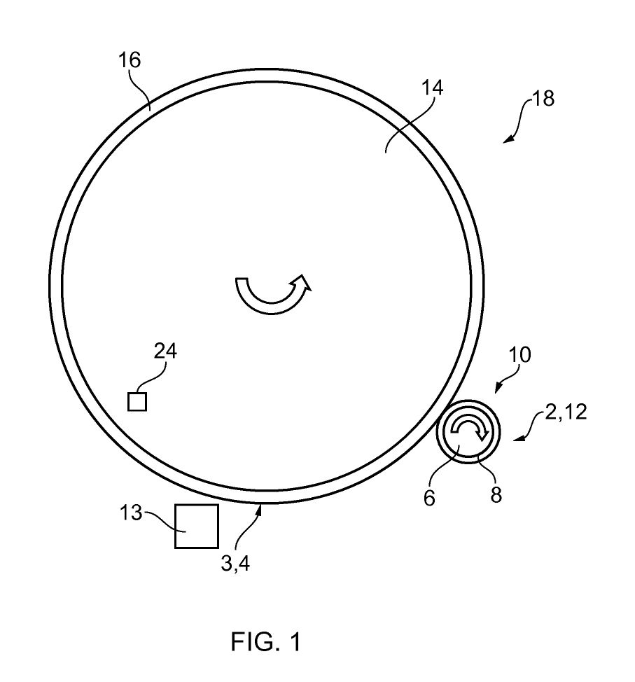

FIG. 1 illustrates an apparatus according to an example;

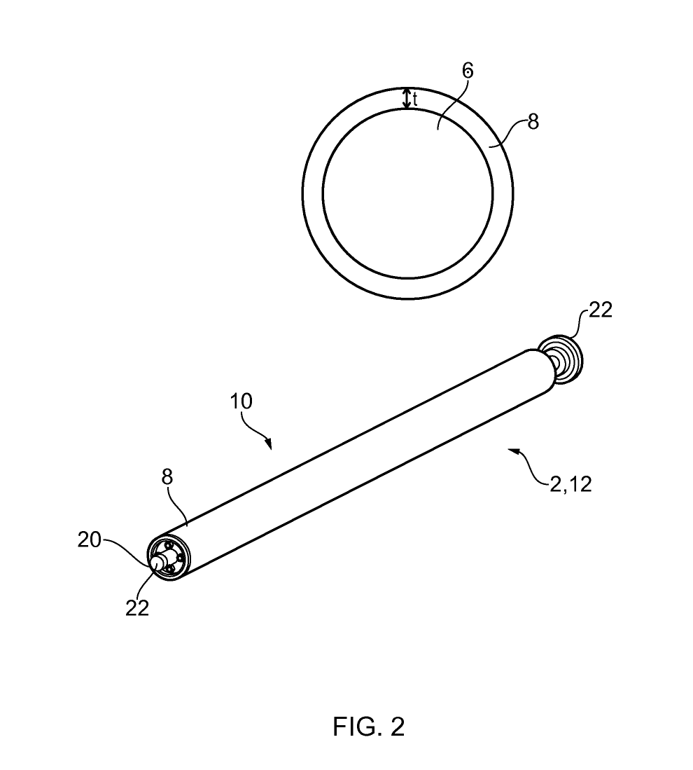

FIG. 2 illustrates a roller according to an example;

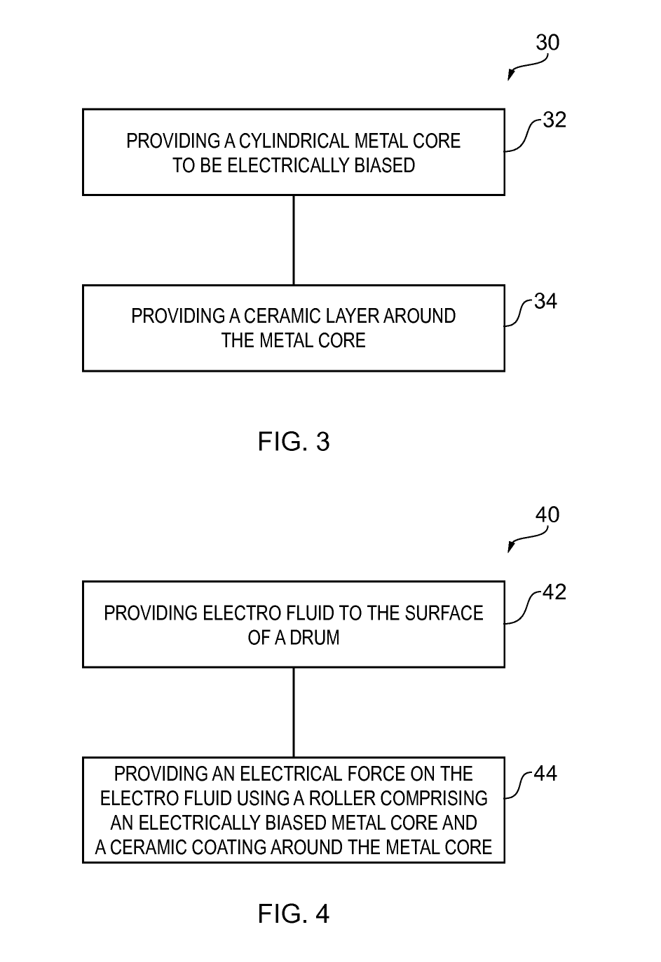

FIG. 3 illustrates a method according to an example; and

FIG. 4 illustrates a method according to an example.

### DETAILED DESCRIPTION

FIG. 1 illustrates an apparatus 18 to concentrate electro fluid 3, comprising an electrically grounded drum 14; a fluid feed 1 to provide electro fluid 3 to the surface of the drum 14; and a roller 12, the roller 12 comprising: a metal core 6 to be electrically biased; and a ceramic coating 8 around the metal core.

FIGS. 1 and 2 illustrate a member 2 to concentrate ink 4, comprising a metal core 6 and a ceramic coating 8 around the metal core 6.

FIGS. 1 and 2 also illustrate a roller 12, comprising a cylindrical metal core 6 to be electrically biased and a ceramic layer 8 around the metal core 6.

FIG. 1 illustrates an example of an apparatus 18 to concentrate electro fluid 3, for example ink 4. In examples the electro fluid 3 is an electrically charged fluid. For example the electro fluid 3 may be negatively charged ink 4 for use in digital liquid electrophotography.

In the illustrated example, the apparatus 18 comprises a drum 14, a member 2 to concentrate electro fluid 3 and an fluid feed 13 to provide electro fluid 3 to the surface of the drum 14. In the illustrated example, the member 2 is a roller 12.

In the example of FIG. 1 the drum 14 is made from aluminium alloy and has a hard anodized coating 16. However, in other examples the drum may be made from any suitable material.

The drum 14 comprises one or more electrical connectors 24 to electrically ground the drum 14.

The roller 12 comprises a ceramic coating 8 around a metal core 6. In some examples, the ceramic coating 8 is a layer 8 that forms a shell 10 around the metal core 6.

In the illustrated examples, the roller 12 is in contact with the drum 14 and the ceramic coating 8 around the metal core 6 separates the metal core 6 from the drum 14. In some examples the roller 12 may be considered a concentration roller.

In some examples the apparatus 18 is to concentrate ink 4 to be used in digital liquid electrophotography (LEP). The ink 4 may be negatively charged and may be concentrated using electrophoretic ink concentration. However, in other examples any suitable electro ink or other electro fluid 3 may be concentrated using the apparatus 18.

For the sake of clarity only the drum 14, the roller 12 and the fluid feed 13 have been illustrated in the example of FIG. 1. However, the apparatus 18 may comprise any number of additional components. For example, the apparatus 18 may comprise a blade to remove ink 4 from the drum 14 after the concentration process.

In use, electro fluid 3 is supplied to the surface of the drum 14 by the fluid feed 13. In the example of FIG. 1, the electro fluid is supplied at the bottom area of the drum 14. In the illustrated example the drum 14 rotates anti-clockwise transporting the electro fluid 3 on the surface of the drum 14 towards the roller 12. In other examples, the drum 14 may rotate clockwise and the position of the roller 12 changed accordingly.

In use, the metal core 6 of the roller 12 is electrically biased. For example, the metal core 6 may be electrically biased at 2.5 kilovolts or 4 kilovolts. In examples, the metal core 6 may be electrically biased in the range 2 to 7 kilovolts. In other examples the metal core 6 of the roller 12 may be electrically biased in the range 50 volts to 1500 volts. In other examples, the metal core 6 of the roller 12 may be electrically biased in the range 50 volts to 7 kilovots.

The ceramic coating 8 of the roller 12 has low conductivity and allows a very small current on the electrically biased roller 12 without electrical breakdown between the roller 12 and the drum 14. For example the electrical resistance of the ceramic coating 8 may be 5 megaohms. In some examples the electrical resistance of the ceramic coating may be in the range 1 megaohm to 10 megaohms. In other examples the electrical resistance of the ceramic coating may be in the range of 10 kiloohms to 100 megaohms.

In use the current on the roller 12 may be, for example, in the range of 0.4 milliamps to 1.5 milliamps.

A strong electric field is produced between the electrically biased roller 12 and the grounded drum 14 without electrical breakdown. The electric field produces an electrical force on the electro fluid 3.

In addition, the roller 12, which in the example is in contact with the drum 14, provides a mechanical force on the electro fluid 3.

The combination of the mechanical force and the electrical force on the electro fluid 3 causes concentration of the electro fluid 3.

The illustrated apparatus 18 provides therefor for concentration of electro fluid 3, such as ink 4 for use in digital liquid electrophotography, via electrophoretic ink concentration. This allows for example, for electro fluid 3 such as ink 4 to be transported to users of digital LEP printers in concentrated form and reduces the amount of ink to be transported. The ink may then be diluted before use in a printer. This provides for a reduction in delivered quantities of ink reducing shipping and packaging costs and also providing environmental benefits.

Furthermore, the ceramic coating 8 around the metal core 6 of the roller 12 does not break down over time under the high electric field and therefore does not require periodical replacement or does not require replacement as frequently.

This provides a clear advantage over use of, for example, rubber around the metal core 6 as under a high electrical field the rubber deteriorates with time and the resistivity of the rubber becomes higher. The varying resistivity of rubber affects the effectiveness and stability of the process and eventually the roller 12 requires replacement.

Accordingly, a roller 12 as illustrated in the example of FIG. 1 provides for a more stable concentration process as the ceramic coating 8 does not deteriorate with time and also for savings with regard to maintenance and replacement parts.

After passing the roller 12 the output electro fluid 3 is concentrated compared to the electro fluid 3 that has not passed the roller 12. The roller 12 may therefore be considered a concentration stage.

In the example of FIG. 1 a single concentration stage is illustrated. However, in other examples further concentration stages may be included, for example, a second roller 12 providing a second concentration stage may be included to further concentrate the ink 4 that has passed the first roller 12.

In some examples, the second and any subsequent concentration stages may not be in the same form as the first roller 12. For example, a second concentration stage may comprise a different member 2 instead of a roller 12.

In other examples, a second concentration stage may comprise a roller 12 substantially the same as the illustrated roller 12 but may be electrically biased at a different voltage. For example, a first roller 12 may be electrically biased at 2.5 kilovolts and a second roller may be electrically biased at 4 kilovolts.

FIG. 2 illustrates an example of a roller 12. The roller 12 in the example of FIG. 2 may be the member 2 illustrated in the example of FIG. 1.

The roller 12 in the example of FIG. 2 comprises a metal core 6 and a ceramic layer 8 around the metal core 6.

In the illustrated example, the metal core is cylindrical and has a substantially constant diameter along its length. As can be seen from FIG. 2, the ceramic layer forms a shell 10 around the cylindrical metal core 6.

The roller 12 in the example of FIG. 2 comprises mechanical connectors 22 to allow, for example, the roller 12 to operate in an apparatus such as the apparatus 18 illustrated in the example of FIG. 1. In the illustrated example, the mechanical connectors 22 allow the roller 12 to be held in position and rotated as may be required. For example, the roller 12 may have bearings at both ends of the roller 12 that are fixed in the stationary frame.

In other examples the roller 12 may comprise any suitable mechanical connector or connectors.

In the illustrated example the roller 12 also comprises an electrical connector or connectors 20 to allow the roller 12 to be electrically biased. In examples any number of electrical connectors may be used and any suitable form of electrical connectors may be used.

The upper image in the example of FIG. 2 shows a cross-section of the roller 12. In the cross-section it can be seen that the ceramic layer 8 has a thickness t. The thickness t of the ceramic layer 8 defines the electrical resistance of the layer 8 and hence the electrical resistance of the roller 12. In the example of electro fluid concentration the resistance of the roller 12 governs the main parameters of the concentration process, for example, in the example where the electro fluid 3 is ink 4, the concentration percentage of the ink 4 and the throughput of the ink 4.

In examples, the thickness of the ceramic layer 8 may be 0.4 millimetres. In some examples the thickness of the ceramic layer 8 may be in the range 0.35 millimetres to 0.5 millimetres. In other examples the thickness of the ceramic layer may be in the range 0.1 to 0.9 millimetres.

The ceramic layer may be any suitable ceramic material having a sufficiently high electrical resistance and an appropriate thickness. For example the ceramic material may have an electrical resistance in the range/ranges described above and a thickness in the range/ranges described above. In some examples “Mitco 105” or “Mitco 101” from MPC Industries and Research Carmiel Ltd may be used. The ceramic layer may be formed from thermal spray coating.

In general, any suitable ceramic material may be used.

The metal core may comprise any suitable metal, for example steel, stainless steel or aluminium.

FIG. 3 illustrates an example of a method 30 to manufacture a roller 12. For example, a roller 12 as illustrated in the examples of FIG. 1 and/or FIG. 2.

At block 32 a cylindrical metal core to be electrically biased is provided. For example, the cylindrical metal core of FIG. 2 comprising one or more electrical connectors may be provided.

At block 34 a ceramic layer around the metal core 6 is provided. For example, the ceramic layer 8 as illustrated in the example of FIG. 2 may be provided.

FIG. 4 illustrates an example of a method 40 to concentrate an electro fluid 3. In some examples the method may be performed by the apparatus 18 illustrated in the example of FIG. 1.

At block 42 electro fluid 3 is provided to the surface of a drum 14. For example, the electro fluid 3 may be provided to the surface of the drum 14 by the fluid feed 13 in the example of FIG. 1. In some examples the electro fluid 3 may be ink 4. For example ink 4 for use in digital liquid electrophotography.

At block 44 an electrical force is provided on the electro fluid 3 using a roller 12 comprising an electrically biased metal core 6 and a ceramic coating 8 around the metal core 6. For example, the electrical force may be provided on the electro fluid using the roller 12 illustrated in the example of FIG. 1

The electrical force causes concentration of the electro fluid 3.

In some examples the method 40 may comprise additional blocks. For example, the method 40 may comprise a block in which a mechanical force is provided to the electro fluid 3, for example using the roller 12 comprising an electrically biased metal core 6 and a ceramic coating 8 around the metal core.

The mechanical force may be provided to the electro fluid 3 at the same time as the electrical force and the combination of the mechanical force and the electrical force causes concentration of the electro fluid 3.

In some examples the providing of the electrical force and/or the mechanical force by a roller 12 comprising an electrically biased metal core 6 and a ceramic coating 8 around the metal core 6 may be repeated. For example two separate rollers 12 may be used.

In some examples the method 40 may comprise a block in which the concentrated electro fluid 3 is removed from the surface of the drum 14. For example a blade may be used to remove the concentrated electro fluid from the surface of the drum 14.

The blocks illustrated in the FIGS. 3 and 4 may represent steps in a method. The illustration of a particular order to the blocks does not necessarily imply that there is a required or preferred order for the blocks and the order and arrangement of the block may be varied. Furthermore, it may be possible for some blocks to be omitted.

Although examples of the present invention have been described in the preceding paragraphs, it should be appreciated that modifications to the examples given can be made without departing from the scope of the invention as claimed. For example, the member 2 may not be a roller 12 but may in some examples be a plate such as a flat plate or an arced plate. In some examples, the member 2 in FIG. 1 may be an arced sheet of metal located at a small distance from the drum 14. The arced sheet of metal may produce the electrical field against the drum 14.

In other examples, the roller 12 illustrated in FIG. 2 may not be used in a concentration process but may have different functionality. For example, the roller 12 may be a charge roller.

In some examples the roller 12 may be used in a printing apparatus such as a printing press. For example, the roller 12 may be used in printing using conductive ink.

Features described in the preceding description may be used in combinations other than the combinations explicitly described.

Although functions have been described with reference to certain features, those functions may be performable by other features whether described or not.

Although features have been described with reference to certain examples, those features may also be present in other examples whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus to concentrate electro fluid, comprising:
an electrically grounded drum;
a fluid feed to provide electro fluid to the surface of the drum; and
a roller, the roller comprising:
a metal core to be electrically biased; and
a ceramic coating around the metal core.

2. An apparatus as claimed in claim 1, wherein the ceramic coating forms a shell around the metal core.

3. An apparatus as claimed in claim 1, wherein the roller is in contact with the drum.

4. An apparatus as claimed in claim 1, wherein the ceramic coating has an electrical resistance in the range 10 kiloohms to 100 megaohms.

5. An apparatus as claimed in claim 1, wherein the thickness of the ceramic coating is in the range 0.1 millimetres to 0.9 millimetres.

6. An apparatus as claimed in claim 1, wherein the metal core comprises steel, stainless steel or aluminium.

7. An apparatus as claimed in claim 1, wherein the electro fluid is ink.

8. An apparatus to concentrate electro ink, comprising:
a drum comprising an electrical connector to electrically ground the drum;
an ink supplier to feed electro ink to the surface of the drum; and
a member, the member comprising:
a cylindrical metal core comprising an electrical connector to electrically bias the metal core; and
a ceramic layer around the metal core.

9. An apparatus as claimed in claim 8, wherein the metal core is to be electrically biased in the range 50 volts to 7 kilovolts.

10. An apparatus as claimed in claim 8, wherein the ceramic layer forms a coating around the metal core.

11. An apparatus as claimed in claim 8, wherein the ceramic layer has an electrical resistance in the range 10 kiloohms to 100 megaohms

12. An apparatus as claimed in claim 8, wherein the apparatus is to concentrate ink for use in digital liquid electrophotography.

13. An apparatus as claimed in claim 8, wherein the thickness of the ceramic layer is in the range 0.1 millimetres to 0.9 millimetres.

14. An apparatus as claimed in claim 8, wherein the metal core comprises steel, stainless steel or aluminium.

15. A method to concentrate electro fluid, comprising:
providing electro fluid to the surface of a drum;
providing an electrical force on the electro fluid using a roller comprising an electrically biased metal core and a ceramic coating around the metal core.
